(19) United States
(12) Patent Application Publication
(10) Pub. No.: US 2020/0179982 A1
(43) Pub. Date: Jun. 11, 2020

(54) SEQUENCER DEVICE

(71) Applicant: NTEX Transportation Services Pvt. Ltd., Pune (IN)

(72) Inventors: Tanay SHAH, Pimpri-Chinchwad (IN); Pushkar OKE, Pimpri-Chinchwad (IN); Vaibhav AGRAWAL, Pimpri-Chinchwad (IN); Yogesh KULKARNI, Pimpri-Chinchwad (IN)

(73) Assignee: NTEX Transportation Services Pvt. Ltd., Pune (IN)

(21) Appl. No.: 16/452,367

(22) Filed: Jun. 25, 2019

(30) Foreign Application Priority Data
Dec. 11, 2018 (IN) 201821046814

(51) Int. Cl. B07C 3/08

(52) U.S. Cl. CPC B07C 3/082

(57) ABSTRACT

The present disclosure provides a sequencer device, communicatively coupled to a system, for arranging a plurality of shipments in order of delivery. The sequencer device includes a plurality of frames. Each of the plurality of frames includes a plurality of carrier plates. The sequencer device includes a loading mechanism. The sequencer device includes a plurality of support columns. The sequencer device includes a plurality of rotation modules. The sequencer device includes an unloading mechanism. The unloading mechanism unloads each of the plurality of shipments in order of delivery. The sequencer device receives sequence for sequencing the plurality of shipments from the system. The sequencer device enables physical sequencing of the plurality of shipments.

### TECHNICAL FIELD

The present disclosure relates to the field of logistics. More particularly, the present disclosure relates to a sequencer device for sequencing shipments in order of delivery.

### INTRODUCTION

Over the last few years, there has been a significant rise in e-commerce industry. This rise has in turn led to an increase in demand for logistics along with an increase in demand to deliver shipments in minimum time. Typically, delivery time of shipment depends on various factors. The various factors include drop-off time of the shipments. The drop-off time corresponds to time taken by a delivery associate to deliver the shipments from a delivery warehouse to various customers. The drop-off time includes time taken by the delivery associate to sequence the shipments according to preferred delivery route of the delivery associate. Currently, the shipments are sequenced manually by the delivery associate. However, manual sequencing of the shipments consumes a lot of time. In addition, manual sequencing of the shipments induces errors in sequencing. Moreover, manual sequencing of the shipments is not an optimized sequencing. Also, manual sequencing of the shipments requires skilled delivery associates to deal with it. Efficiency of manual sequencing of the shipments depends on skill set of the delivery associate.

In light of the above stated discussion, there is a need for a device which can automate the shipment sequencing process and remove dependencies on delivery associates.

### SUMMARY

The present disclosure provides a sequencer device, communicatively coupled to a system, for arranging a plurality of shipments in order of delivery. The sequencer device includes a plurality of frames. Each of the plurality of frames is positioned horizontally. The plurality of frames is stacked about a first axis, separated by a first vertical distance along the first axis. Each of the plurality of frames comprising a plurality of carrier plates. The sequencer device includes a loading mechanism. The loading mechanism positions each of the plurality of shipments in a carrier plate of the plurality of carrier plates. The sequencer device includes a plurality of support columns. Each of the plurality of support columns is arranged vertically around periphery of the plurality of frames. The plurality of support columns provides mechanical support to each of the plurality of frames. The sequencer device includes a plurality of rotation modules. One or more of the plurality of rotation modules is associated with each of the plurality of frames. Each of the plurality of rotation modules enables corresponding frame of the plurality of frames to rotate about the first axis. The sequencer device includes an unloading mechanism. The unloading mechanism unloads each of the plurality of shipments in order of delivery. The unloading mechanism inclines a carrier plate of the plurality of carrier plates for unloading corresponding shipment of the plurality of shipments in to a conical collector. The sequencer device receives sequence for sequencing the plurality of shipments from the system. The sequencer device enables physical sequencing of the plurality of shipments.

In an embodiment of the present disclosure, the sequencer device includes at least one scanner. The at least one scanner scan the plurality of shipments to retrieve a first set of data associated with each of the plurality of shipments.

In an embodiment of the present disclosure, the sequencer device includes a plurality of sensors. Each of the plurality of sensors is selected from a group. The group includes infrared sensors, optical sensors, ultrasonic sensors, and tilt sensors.

In an embodiment of the present disclosure, each of the plurality of frames comprising one or more hollow carrier plates. The one or more hollow carrier plate facilitates in loading the plurality of shipments in to the plurality of carrier plates.

In an embodiment of the present disclosure, the plurality of frames is of circular shape. Circular shape of the plurality of frames is characterized by a first geometrical center. Each of the plurality of frames comprising a circular cavity centered at the first geometrical center. The first axis is passing through the first geometrical center of the plurality of frames.

In an embodiment of the present disclosure, the sequencer device includes a communication module. The communication module communicatively couples the sequencer device with the system.

In an embodiment of the present disclosure, each of the plurality of carrier plates is affixed with corresponding frame of the plurality of frames with facilitation of an inclination mechanism. The inclination mechanism facilitates the plurality of carrier plates to incline at a pre-defined angle. The unloading mechanism enables the plurality of carrier plates to incline at the pre-defined angle.

In an embodiment of the present disclosure, the unloading mechanism includes either a plurality of unloading actuators or a plurality of unloading motors. Each of the plurality of carrier plates comprising an unloading actuator of the plurality of unloading actuators. Each of the plurality of unloading actuators inclines the corresponding carrier plate of the plurality of carrier plates. The plurality of unloading motors is installed on one or more of the plurality of support columns. Each of the plurality of frames is coupled to one or more of the plurality of unloading motors. Each of the plurality of unloading motors inclines the plurality of carrier plates of corresponding frame of the plurality of frames.

In an embodiment of the present disclosure, the sequencer device includes a power module. The power module provides electrical power for operations of the sequencer device.

In an embodiment of the present disclosure, the sequencer device includes one or more mesh structures. The one or more mesh structures ensure damage-free sequencing of the plurality of shipments.

### BRIEF DESCRIPTION OF THE DRAWINGS

Having thus described the disclosure, in general, terms, reference will now be made to the accompanying figures, wherein:

FIG. 1A illustrates a cross sectional view of a sequencer device communicatively coupled with a system, in accordance with various embodiment of the present disclosure;

FIG. 1B illustrates a top view of the sequencer device of FIG. 1A, in accordance with various embodiments of the present disclosure; and

FIG. 1C illustrates the cross sectional view of an unloading mechanism, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

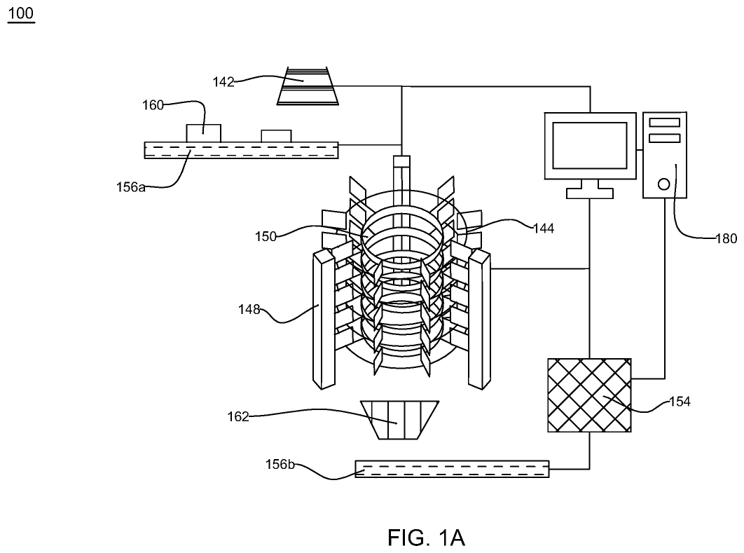

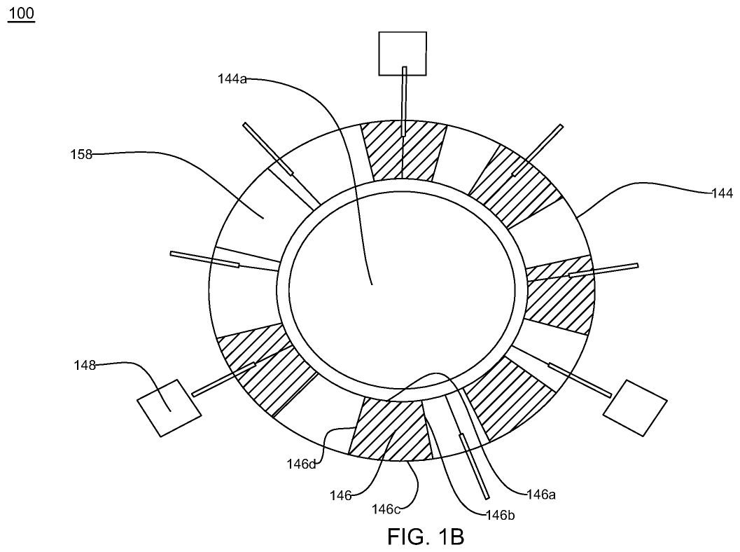

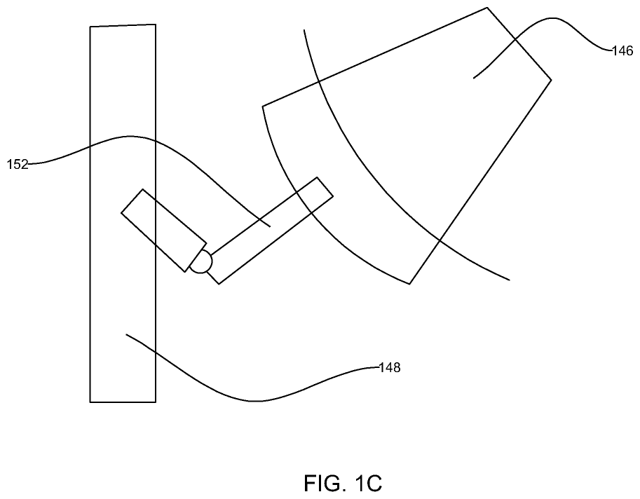

FIG. 1A illustrate a cross sectional view of a sequencer device 100, in accordance with various embodiments of the present disclosure. FIG. 1B illustrates a top view of the sequencer device 100, in accordance with various embodiments of the present disclosure. In general, sequencer device 100 is a device employed for systematic arranging, and sequencing of shipments lying in a specific size range in a pre-specified order. The sequencer device 100 enables sequencing of shipments of a specific size range. In general, shipment corresponds to a parcel, package or envelope to be delivered to a particular customer. The sequencer device 100 is communicatively coupled to a system 180. The system 180 determines a delivery sequence or order of delivery for sequencing of shipments. In general, delivery sequence or order of delivery corresponds to customized sequential order for delivering shipments to corresponding customer of a plurality of customers. The system 180 processes data associated with the shipments to enable the delivery sequence for sequencing of the shipments. In an embodiment of the present disclosure, the system 180 enables a delivery associate to provide order of delivery or the delivery sequence. The sequencer device 100 physically sequences the shipments according to the delivery sequence provided by the system 180. The sequencer device 100 scans the shipments to provide data of the shipments to the system 180. The sequencer device 100 includes various components and mechanisms. The sequencer device 100 operates with facilitation of electrical energy.

The sequencer device 100 is loaded with the shipments with facilitation of suitable mechanism. The sequencer device 100 retrieves data from the shipments automatically based on scanning of the shipments. The sequencer device 100 may include embedded scanning components. The shipments are positioned within corresponding slots provided in the sequencer device 100. The sequencer device 100 receives signals from the system 180 for sequencing of the shipments. Accordingly, the sequencer device 100 dispenses each of the shipments in the delivery sequence with facilitation of a dispensing mechanism. The shipments after dispensing are collected in order of delivery in a collector mechanism. The sequencer device 100 sequences the shipment in order of delivery to enable the delivery associate to quickly deliver the shipments without any further sequencing. The sequencer device 100 enables the delivery associate to deliver the shipments in reduced time.

The sequencer device 100 includes at least one scanner 142, a plurality of frames 144, a plurality of carrier plates 146 and a plurality of support columns 148. Further, the sequencer device 100 includes a plurality of rotation modules 150, a loading mechanism, an unloading mechanism 152 and a power supply module 154. In addition, the sequencer device 100 includes a loading motorized belt 156a, an unloading motorized belt 156b and a conical collector 162. The sequencer device 100 enables sequencing of a plurality of shipments 160. Various components of the sequencer device 100 collectively enable physical sequencing of the plurality of shipments 160. The sequencer device 100 dispenses the plurality of shipments 160 in order of delivery. The sequencer device 100 receives the order of delivery from the system 180. In an embodiment of the present disclosure, the sequencer device 100 includes any suitable components of the like.

The sequencer device 100 includes the at least one scanner 142. The at least one scanner 142 scans each of the plurality of shipments 160. The at least one scanner 142 is positioned in a scanning area of the sequencer device 142. The scanning area includes the at least one scanner 142 and the loading motorized belt 156a. The loading motorized belt 156a moves the plurality of shipments 160 through the scanning area at a uniform speed. In an embodiment of the present disclosure, the scanning area includes any suitable components of the like. The at least one scanner 142 scans each of the plurality of shipments 160 to retrieve a first set of data associated with a shipment of the plurality of shipments 160. The first set of data includes characteristic data of the corresponding shipment of the plurality of shipments 160.

The system 180 is communicatively coupled with the sequencer device 100. The system 180 receives and processes the scanned data to enable the first set of data for each of the plurality of shipments 160. The first set of data includes delivery address data of shipment. The first set of data includes preferences of user associated with shipment. The first set of data includes instructions for handling shipment. In an embodiment of the present disclosure, the first set of data includes any suitable data of the like.

In an embodiment of the present disclosure, each of the plurality of shipments 160 includes one or more barcodes. The at least one scanner 142 scans the one or more barcodes of each of the plurality of shipments 160. The system 180 is associated with a central system. The central system stores the first set of data of each of the plurality of shipments 160 provided by corresponding user of plurality of users. The central system stores the first set of data of each of the plurality of shipments 160 with reference to the one or more barcodes. The system 180 receives the barcode data from the at least one scanner 142. The system 180 retrieves the first set of data from the central system with facilitation of the barcode data. In another embodiment of the present disclosure, each of the plurality of shipments 160 includes any suitable, machine readable, representation of data and the like. In yet another embodiment of the present disclosure, each of the plurality of shipments 160 includes any suitable data representation of the like.

The sequencer device 100 includes the plurality of frames 144. In general, frame of a device corresponds to a rigid structure to provide mechanical support to various other elements of the device. Each of the plurality of frames 144 is positioned horizontally. Each of the plurality of frames 144 is positioned parallel to ground. The plurality of frames 144 are positioned parallel to one another. The plurality of frames 144 is stacked as one frame of the plurality of frames 144 over another frame of the plurality of frames 144. The plurality of frames 144 are stacked about a first axis and separated by a first vertical distance along the first axis. The first vertical distance along the first axis is optimized to ensure safe handling of each of the plurality of shipments 160. The first vertical distance is optimized to eliminate any damage to the plurality of shipments 160. In an embodiment of the present disclosure, the first vertical distance lies in any suitable range of the like.

The plurality of frames 144 are of circular shape. The circular shape of the plurality of frames 144 is characterized by a first geometrical center. In general, geometrical center corresponds to arithmetic mean position of all points in a shape or geometry. The first geometrical center is center of the circular shape of each of the plurality of frames 144. Each of the plurality of frames 144 is characterized by a first plane. The first plane corresponds to plane of flat circular surface of each of the plurality of frames 144. The first plane of each of the plurality of frames 144 is parallel to ground. In an embodiment of the present disclosure, the first plane is any suitable plane of the like. Each of the plurality of frames 144 have equal diameter. Each of the plurality of frames 144 is characterized by a first diameter. The first diameter is diameter of circular geometry of the plurality of frames 144. In an embodiment of the present disclosure, the first diameter of each of the plurality of frames 144 lies in any suitable range. In an embodiment of the present disclosure, each of the plurality of frames 144 is of any suitable shape of the like.

Further, each of the plurality of frames 144 includes a circular cavity 144a. The circular cavity 144a of each of the plurality of frames 144 is centered at the first geometrical center. The circular cavity 144a is concentric to the circular shape of corresponding frame of the plurality of frames 144. The circular cavity 144a of each of the plurality of frames 144 is characterized by a second diameter. The second diameter is diameter of circular geometry of the circular cavity 144a. The second diameter is less than the first diameter. In an embodiment of the present disclosure, the second diameter of each of the circular cavity 144a lies in any suitable range. The pluralities of frames 144 are stacked as one frame of the plurality of frames 144 over another frame of the plurality of frames 144 with the first geometrical center of each of the plurality of frames 144 lying on the first axis. The first axis is an imaginary axis. The first axis extends perpendicular to the ground. The first axis passes through the first geometrical center of each of the plurality of frames 144.

The sequencer device 100 includes the plurality of carrier plates 146. Each of the plurality of frames 144 includes the plurality of carrier plates 146. Each of the plurality of carrier plates 146 receives a shipment of the plurality of shipments 160. Each of the plurality of carrier plates 146 is designed to accommodate a shipment of the plurality of shipments 160. Each of the plurality of carrier plates 146 is affixed with corresponding frame of the plurality of frames 144 with facilitation of an inclination mechanism. In general, the inclination mechanism enables a body to incline at any pre-defined angle about an axis. The plurality of carrier plates 146 are of pre-defined shape and size. Each of the plurality of frames 144 includes a plurality of cavities. In general, cavity corresponds to a hollow space within a solid body. Each of the plurality of frames 144 includes equal number of plurality of cavities and the plurality of carrier plates 146.

The plurality of carrier plates 146 are affixed in the plurality of cavities in each of the plurality of frames 144. The plurality of carrier plates 146 are affixed in the plurality of cavities with facilitation of the inclination mechanism. Each of the plurality of cavities is characterized by a second geometrical center. The second geometrical center is an imaginary center of each cavity of the plurality of cavities. The plurality of cavities in each of the plurality of frames 144 are distributed circularly around the circular cavity 144a. The second geometrical center of each of the plurality of cavities in corresponding frame of the plurality frames 144 is equidistant from the first geometrical center of corresponding frame of the plurality of frames 144.

The plurality of cavities in each of the plurality of frames 144 are identical in shape and size to the plurality of carrier plates 146. Each of the plurality of carrier plates 146 is characterized by a second plane. The second plane is plane of carrier plate of each of the plurality of carrier plates 146. Each of the plurality of carrier plates 146 is affixed to corresponding frame of the plurality of frames 144 with the second plane parallel to ground. Each of the plurality of carrier plates 146 is affixed to corresponding frame of the plurality of frames 144 with the first plane coplanar to the second plane. Each of the plurality of carrier plates 146 includes a first side 146a, a second side 146b, a third side 146c and a fourth side 146d. The inclination mechanism facilitates the plurality of carrier plates 146 to incline at a first pre-defined angle. The inclination mechanism facilitates the plurality of carrier plates 146 to incline towards ground at the first pre-defined angle. The inclination mechanism facilitates each of the plurality of carrier plates 146 to incline about the first side 146a at the first pre-defined angle. In an embodiment of the present disclosure, the plurality of carrier plates 146 inclines at any suitable angle of the like. In an embodiment of the present disclosure, the inclination mechanism is a hinge mechanism. In another embodiment of the present disclosure, the inclination mechanism is any suitable mechanism of the like.

One or more of the plurality of frames 144 includes one or more hollow carrier plates 158. In general, hollow carrier plate corresponds to a carrier plate with solid periphery and hollow body. The one or more hollow carrier plates 158 are characterized by a peripheral shape. The peripheral shape corresponds to shape of periphery of the one or more hollow circular plates 158. The peripheral shape of the one or more hollow carrier plates 158 is identical to peripheral shape of the plurality of carrier plates 146. The one or more hollow carrier plates 158 facilitates in loading the plurality of shipments 160 on to the plurality of carrier plates 146. The one or more hollow carrier plates 158 enables the loading mechanism to place each of the plurality of shipments 160 in a carrier plate of the plurality of carrier plates 146. The one or more hollow carrier plates 158 of corresponding frame of the plurality of frames 144 allows a shipment of the plurality of shipments 160 to be moved to a lower frame of the plurality of frames 144 for loading. The lowermost frame of the plurality of frame 144 does not include one or more hollow carrier plate 158.

The sequencer device 100 includes the loading mechanism. The loading mechanism positions each of the plurality of shipments 160 in a carrier plate of the plurality of carrier plates 146. The loading mechanism receives each of the plurality of shipments 160 from the loading motorized belt 156a. The loading mechanism receives each of the plurality of shipments 160 from the loading motorized belt 156a and positions on the corresponding plate of the plurality of plates 146. The system 180 assigns a unique identification number to each of the plurality of carrier plates 146. The system 180 stores position of each of the plurality of shipments 160 with respect of the corresponding plate of the plurality of plate 146. The system 180 stores position of each shipment of the plurality of shipments 160 and the unique identification number of corresponding carrier plate of the plurality of carrier plates 146. The system 180 stores the first set of data against the unique identification number of corresponding carrier plate of the plurality of carrier plates 146. In an embodiment of the present disclosure, the sequencer device 100 is loaded manually. In another embodiment of the present disclosure, the sequencer device 100 is loaded with facilitation of any suitable mechanism of the like.

The sequencer device 100 includes the plurality of support columns 148. In general, column corresponds to an upright pillar positioned orthogonally to ground supporting a structure. Each of the plurality of support columns 148 is arranged vertically around periphery of the plurality of frames 144. The plurality of support columns 148 is arranged equidistant from one another around periphery of the plurality of frames 144. The plurality of support columns 148 provide mechanical support to each of the plurality of frames 144. The plurality of support columns 148 is straight and non-tapered. Each of the plurality of support columns 148 is characterized by a cross sectional shape. The cross sectional shape includes square, rectangle or circle. In an embodiment of the present disclosure, each of the plurality of support columns 148 is of any suitable shape of the like.

Further, the sequencer device 100 includes the plurality of rotation modules 150. The plurality of rotation modules 150 enables the plurality of frames 144 to rotate about the first axis. Each of the plurality of frames 144 is associated with one of the plurality of rotation modules 150. Each of the plurality of frames 144 includes one or more of the plurality of rotation modules 150. Each of the plurality of rotation modules 150 enables corresponding frame of the plurality of frames 144 to rotate about the first axis. The plurality of rotation modules 150 rotates the plurality of frames 144 to facilitate in loading and unloading of the sequencer device 100. The plurality of rotation modules 150 enables the plurality of frames 144 to rotate at a plurality of second pre-defined angles. The plurality of second pre-defined angles lies in a range of 1 degree to 360 degree. The plurality of rotation modules 150 enables the plurality of frames 144 to rotate independently of one another. In an embodiment of the present disclosure, each of the plurality of frames 144 includes a rotation module of the plurality of rotation modules 150.

FIG. 1C illustrates cross sectional view of the unloading mechanism 152, in accordance with an embodiment of the present disclosure. The sequencer device 100 includes the unloading mechanism 152. The unloading mechanism 152 enables unloading of each of the plurality of shipments 160 in order of delivery. The unloading mechanism 152 enables unloading of each of the plurality of shipments 160 in order of delivery by selectively inclining the plurality of carrier plates 146. The unloading mechanism 152 selectively inclines the plurality of carrier plates 146 to unload each of the plurality of shipments 160. The unloading mechanism 152 inclines the plurality of carrier plates 146 to unload the plurality of shipments 160 through the circular cavity 144a. The unloading mechanism 152 inclines corresponding carrier plate of the plurality of carrier plates 146 to unload corresponding shipment of the plurality of shipments 160. The unloading mechanism 152 inclines the plurality of carrier plates 146 at the first pre-defined angle. The first pre-defined angle lies in a range of about 30 degrees to 90 degrees. In an embodiment of the present disclosure, the first pre-defined angle lies in any suitable range of the like. The unloading mechanism 152 inclines the plurality of carrier plates 146 with facilitation of the inclination mechanism.

The sequencer device 100 receives the delivery sequence or order of delivery from the system 180. The unloading mechanism 152 enables unloading of the plurality of shipments 160 according to the delivery sequence or order of delivery. The unloading mechanism 152 inclines the carrier plate of the plurality of carrier plates 146 for unloading the shipment of the plurality of shipments 160 in to the conical collector 162. The conical collector 162 is designed to smoothly receive the plurality of shipments 160. The conical collector 162 receives and transfers the plurality of shipments 160 to the unloading motorized belt 156b. The conical collector 162 is designed to ensure damage-free transfer of each of the plurality of shipments 160. The unloading motorized belt 156b receives and conveys the plurality of shipments 160 to a pick-up area in order of delivery. The delivery associate is stationed or present at the pick-up area. In general, delivery associate corresponds to a person or individual that delivers shipments door-to-door. The delivery associates accordingly picks up each of the plurality of shipments 160 in order of delivery from the pick-up area. The delivery associate accordingly fills a delivery bag in order of delivery.

The unloading mechanism 152 is selected one from a plurality of unloading actuators or a plurality of unloading motors. The unloading mechanism 152 includes either the plurality of unloading actuators or the plurality of unloading motors. In an embodiment of the present disclosure, the unloading mechanism 152 includes the plurality of unloading actuators. Each of the plurality of carrier plates 146 includes an unloading actuator of the plurality of unloading actuators. Each of the plurality of unloading actuator inclines corresponding carrier plate of the plurality of carrier plates 146. The plurality of unloading actuators inclines each of the plurality of carrier plates 146 in order of delivery. The sequencer device 100 includes equal number of the plurality of carrier plates 146 and the plurality of unloading actuators. Each of the plurality of unloading actuator inclines corresponding carrier plate of the plurality of carrier plates 146 with facilitation of the inclination mechanism.

In another embodiment of the present disclosure, the unloading mechanism 152 includes the plurality of unloading motors. The plurality of unloading motors is installed on one or more of the plurality of support columns 148. Each of the plurality of frames 144 is coupled to one or more of the plurality of unloading motors. Each of the plurality of unloading motors is installed on a support column of the plurality of support columns 148 adjacent to a frame of the plurality of frames 144. Each of the plurality of unloading motors inclines the plurality of carrier plates 146 of corresponding frame of the plurality of frames 144. Each of the plurality of unloading motors includes a rigid bar. Each of the plurality of unloading motors inclines the plurality of carrier plates 146 of corresponding frame of the plurality of frames 144 with facilitation of the rigid bar.

The rigid bar includes a first end and a second end. The first end of the rigid bar is connected to the corresponding unloading motor of the plurality of unloading motors. The second end of the rigid bar inclines corresponding carrier plate of the plurality of carrier plates 146. Corresponding unloading motor of the plurality of unloading motors moves the second end of the rigid bar in downward to upward direction. Each of the plurality of rotation modules 150 rotate corresponding frame of the plurality of frames 144. The rotation enables alignment of a desired carrier plate of the plurality of carrier plates 146 with corresponding unloading motor of the plurality of unloading motor. The second end of the rigid bar is initially positioned at a pre-defined distance below the plurality of carrier plates 146 of corresponding frame of the plurality of frames 144. The plurality of rotation modules 150 rotates the plurality of frames 144 to align a carrier plate of with the second end of corresponding unloading motor.

The second end of the rigid bar lifts the third side 146c of corresponding carrier plate of the plurality of carrier plates 146 to incline the carrier plate about the first side 146a. The second end of the rigid bar lifts the third side 146c of corresponding carrier plate of the plurality of carrier plates 146 to incline the carrier plate towards ground. The plurality of unloading motors inclines the plurality of carrier plates 146 in the delivery sequence or order of delivery. The plurality of unloading motors inclines the plurality of carrier plates 146 in the delivery sequence or order of delivery with facilitation of the plurality of rotation modules 150. In an embodiment of the present disclosure, each of the plurality of frames 144 is coupled with one or more unloading motors of the plurality of unloading motors.

In an embodiment of the present disclosure, the sequencer device 100 includes a plurality of sensors. The sequencer device 100 employs the plurality of sensors to monitor loading and unloading of the plurality of shipments 160. The plurality of sensors monitor position of each of the plurality of shipments 160 in corresponding carrier plate of the plurality of carrier plates 146. The plurality of sensors monitor loading of the plurality of shipments 160. The plurality of sensors monitors unloading of the plurality of shipments 160. The plurality of sensors monitors accurate positioning of each of the plurality of carrier plates 146 with respect to the loading mechanism to ensure accurate loading.

The plurality of sensors monitors accurate positioning of each of the plurality of carrier plates 146 with respect to the unloading mechanism 152 to ensure accurate unloading. The plurality of sensors monitors tilt of each of the plurality of carrier plates 146 to ensure accurate unloading. The plurality of sensors transfers sensed data to the system 180. The plurality of sensors provides sensing signals to the system 180. Each of the plurality of sensors is selected from a group. The group includes infrared sensors, optical sensors, ultrasonic sensors and tilt sensors. In an embodiment of the present disclosure, the plurality of sensors includes any suitable sensors of the like.

The sequencer device 100 includes one or more mesh structures. The one or more mesh structure ensures damage-free sequencing of the plurality of shipments 160. In general, mesh corresponds to a barrier made of connected strands of metal, fiber or other flexible or ductile materials. The one or more mesh structure supports the plurality of shipments 160 during sequencing to avoid damage. The one or more mesh structure supports the plurality of shipments 160 during loading to avoid damage. The one or more mesh structures support the plurality of shipments 160 to slide between the plurality of frames 144. The one or more mesh structure supports the plurality of shipments 160 during unloading to avoid damage. In an embodiment of the present disclosure, the one or more mesh structures support the plurality of shipments 160 in any suitable manner of the like.

In an embodiment of the present disclosure, the sequencer device 100 includes a communication module. The communication module enables the sequencer device 100 to communicate with the system 180. The communication module enables the sequencer device 100 to send one or more signals to the system 180. The communication module enables the sequencer device 100 to receive one or more signals from the system 180. The communication module enables the sequencer device 100 to receive the delivery sequence of order of delivery from the system 180. The communication module enables the sequencer device 100 to send the first set of data to the system 180. The communication module enables the sequencer device 100 to send data provided by the plurality of sensors to the system 180. In an embodiment of the present disclosure, the communication module enables the sequencer device 100 to send and receive signals and from any suitable system or any suitable device.

The sequencer device 100 includes a power module 154. In general, the power module 154 provides electrical power for various operations of a device. The power module 154 stores electrical power. The power module 154 supplies electrical power to enable various operations of the sequencer device 100. In an embodiment of the present disclosure, the power module 154 supplies electrical power to the sequencer device 100 and the system 180. In an embodiment of the present disclosure, the power module 154 converts one or more different forms of energy into electrical energy to provide electrical power to the sequencer device 100.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A sequencer device, communicatively coupled to a system configured for arranging a plurality of shipments in order of delivery, the sequencer device comprising:
a plurality of frames, wherein each of the plurality of frames is positioned horizontally, wherein the plurality of frames are stacked about a first axis, wherein each frame of the plurality of frames is separated by a first vertical distance along the first axis, wherein each of the plurality of frames have equal diameter, wherein each of the plurality of frames comprising a plurality of carrier plates; and
a plurality of support columns, wherein each of the plurality of support columns is arranged vertically around periphery of the plurality of frames, wherein the plurality of support columns provide mechanical support to each of the plurality of frames, wherein the sequencer device receives sequence for sequencing the plurality of shipments from the system, wherein the sequencer device enables physical sequencing of the plurality of shipments.

2. The sequencer device as recited in claim 1, further comprising at least one scanner, wherein the at least one scanner scans the plurality of shipments to retrieve a first set of data associated with each of the plurality of shipments.

3. The sequencer device as recited in claim 1, further comprising a plurality of sensors, wherein each of the plurality of sensors is selected from a group, wherein the group comprising infrared sensors, optical sensors, ultrasonic sensors and tilt sensors.

4. The sequencer device as recited in claim 1, wherein each of the plurality of frames comprising one or more hollow carrier plates.

5. The sequencer device as recited in claim 1, wherein the one or more hollow carrier plates facilitates in loading the plurality of shipments on to the plurality of carrier plates.

6. The sequencer device as recited in claim 1, wherein the plurality of frames are of circular shape, wherein the circular shape of the plurality of frames is characterized by a first geometrical center.

7. The sequencer device as recited in claim 1, wherein each of the plurality of frames comprising a circular cavity centered at the first geometrical center, wherein the first axis is passing through the first geometrical center of the plurality of frames.

8. A sequencer device, communicatively coupled to a system configured for arranging a plurality of shipments in order of delivery, the sequencer device comprising:
a plurality of frames, wherein each of the plurality of frames is positioned horizontally, wherein the plurality of frames are stacked about a first axis, wherein each frame of the plurality of frames is separated by a first vertical distance along the first axis, wherein each of the plurality of frames have equal diameter, wherein each of the plurality of frames comprising a plurality of carrier plates;
a plurality of support columns, wherein each of the plurality of support columns is arranged vertically around periphery of the plurality of frames, wherein the plurality of support columns provide mechanical support to each of the plurality of frames; and
a plurality of rotation modules, wherein one or more of the plurality of rotation modules is associated with each of the plurality of frames, wherein each of the plurality of rotation modules enables corresponding frame of the plurality of frames to rotate about the first axis.

9. The sequencer device as recited in claim 8, further comprising a communication module, wherein the communication module communicatively couples the sequencer device with the system.

10. The sequencer device as recited in claim 8, wherein each of the plurality of carrier plates is affixed with corresponding frame of the plurality of frames with facilitation of an inclination mechanism.

11. The sequencer device as recited in claim 8, wherein the inclination mechanism facilitates the plurality of carrier plates to incline at a pre-defined angle.

12. The sequencer device as recited in claim 8, wherein the sequencer device comprising a power module, wherein the power module provides electrical power for enabling operations of the sequencer device.

13. The sequencer device as recited in claim 8, further comprising one or more mesh structures, wherein the one or more mesh structures ensure damage-free sequencing of the plurality of shipments.

14. A sequencer device, communicatively coupled to a system configured for arranging a plurality of shipments in order of delivery, the sequencer device comprising:
a plurality of frames, wherein each of the plurality of frames is positioned horizontally, wherein the plurality of frames are stacked about a first axis, wherein each frame of the plurality of frames is separated by a first vertical distance along the first axis, wherein each of the plurality of frames have equal diameter, wherein each of the plurality of frames comprising a plurality of carrier plates;
a plurality of support columns, wherein each of the plurality of support columns is arranged vertically around periphery of the plurality of frames, wherein the plurality of support columns provide mechanical support to each of the plurality of frames;
a plurality of rotation modules, wherein one or more of the plurality of rotation modules is associated with each of the plurality of frames, wherein each of the plurality of rotation modules enables corresponding frame of the plurality of frames to rotate about the first axis; and
an unloading mechanism, wherein the unloading mechanism unloads each of the plurality of shipments in order of delivery, wherein the unloading mechanism inclines a carrier plate of the plurality of carrier plates for unloading corresponding shipment of the plurality of shipments in to a conical collector.

15. The sequencer device as recited in claim 14, wherein the unloading mechanism enables the plurality of carrier plates to incline at a pre-defined angle.

16. The sequencer device as recited in claim 14, wherein the unloading mechanism is one of a plurality of unloading actuators, wherein each of the plurality of carrier plates comprising an unloading actuator of the plurality of unloading actuators.

17. The sequencer device as recited in claim 14, wherein each of the plurality of unloading actuators inclines the corresponding carrier plate of the plurality of carrier plates.

18. The sequencer device as recited in claim 14, wherein the unloading mechanism is one of a plurality of unloading motors, wherein the plurality of unloading motors are installed on one or more of the plurality of support columns.

19. The sequencer device as recited in claim 14, wherein each of the plurality of frames is coupled to one or more of the plurality of unloading motors.

20. The sequencer device as recited in claim 14, wherein each of the plurality of unloading motors inclines the plurality of carrier plates of corresponding frame of the plurality of frames.
